(19) United States
(12) Patent Application Publication
(10) Pub. No.: US 2023/0145348 A1
(43) Pub. Date: May 11, 2023

(54) FORCE-DIRECTED GRAPH LAYOUT

(71) Applicant: BRITISH TELECOMMUNICATIONS PUBLIC LIMITED COMPANY, London (GB)

(72) Inventor: Graham WADDINGHAM, London (GB)

(21) Appl. No.: 17/995,199

(22) PCT Filed: Mar. 11, 2021
(86) PCT No.: PCT/EP2021/056228

§ 371 Date: Sep. 30, 2022

(30) Foreign Application Priority Data
Mar. 30, 2020 (EP) 20166792.0
Mar. 30, 2020 (GB) 2004617.3

(51) Int. Cl. G06F 16/901

(52) U.S. Cl. CPC G06F 16/9024

(57) ABSTRACT

A computer implemented method for generating a force-directed layout for a graph is provided together with computer systems and programs for carrying out the method. The graph includes a plurality of vertices and the layout is dependent on a force exerted by each vertex on every other vertex. The method generates an initial layout of the plurality of vertices. The method determines an effect of global interactions based on the force between vertices by: grouping vertices based on their location in the initial layout; and determining an aggregate effect of each group of vertices as a whole. The method determines, for each vertex, an effect of local interactions based on the force with the vertices located in a region of the initial layout proximate to the vertex. The method determines an adjustment to the location of each vertex based, at least in part, on the combined effects of the global and local interactions on that vertex and applies the determined adjustment to each vertex.

### PRIORITY CLAIM

The present application is a National Phase entry of PCT Application No. PCT/EP2021/056228, filed Mar. 11, 2021, which claims priority from EP Patent Application No. 20166792.0, filed Mar. 30, 2020, and GB Patent Application No. 2004617.3, filed Mar. 30, 2020, each of which is hereby fully incorporated herein by reference.

### TECHNICAL FIELD

The present disclosure relates to the generation of force-directed layouts for graphs.

### BACKGROUND

Force-directed graph drawing algorithms can be used to generate a layout for displaying a graph to a user. That is to say, they can be used to position the vertices (or nodes) of the graph in either a two-dimensional or three-dimensional space to create a visualization of the graph for displaying to a user.

Force-directed graph drawing algorithms work by specifying forces that act on the different components (i.e., vertices and/or edges) of a graph. These forces are typically (but not necessarily always) modelled as analogues of various physical forces that occur in the physical world. For example, spring forces modelled on Hooke's law can be applied between pairs of vertices that are connected via an edge in the graph. Similarly, charge forces modelled on Coulomb's law can be applied between each vertex and every other vertex in the graph. Other examples of physical forces that can also be used include, momentum, friction, gravity and magnetic fields. These forces are normally applied to the graph's vertices, but may also be applied to its edges. A layout for the graph can then be generated by finding positions for the vertices of the graph in the two-dimensional or three-dimensional space in which the forces acting on the components of the graph are substantially in equilibrium. Layouts generated in this manner may also be referred to as force-directed layouts.

A force-directed layout of a graph can provide a useful visualization of a graph's structure that improves its cognitive ease, enabling a user to more quickly understand the graph's structure. This is because they can generally achieve a relatively uniform layout of the graph with a relatively low number of crossing edges. Furthermore, such algorithms do not require knowledge of the semantic meaning of the graph being displayed and can operate generically on any given graph. However, the generation of force-directed layouts for graphs is technically complex and computationally expensive. In particular, it can be difficult to generate layouts of complex graphs having a large number of vertices, especially when there is a time constraint, such as when real-time (or near real-time) visualization of a system represented by a graph (such as a computer network) is required. In such situations, it may be impossible to generate a force-directed layout for a graph using conventional techniques.

### SUMMARY

According to a first aspect of this disclosure, there is provided a computer implemented method for generating a force-directed layout for a graph having a plurality of vertices, wherein the layout is dependent on a force exerted by each vertex on every other vertex, the method comprising: generating an initial layout of the plurality of vertices; determining an effect of global interactions based on the force between vertices by: grouping vertices based on their location in the initial layout; and determining an aggregate effect of each group of vertices as a whole; determining, for each vertex, an effect of local interactions based on the force with the vertices located in a region of the initial layout proximate to the vertex; determining an adjustment to the location of each vertex based, at least in part, on the combined effects of the global and local interactions on that vertex; and applying the determined adjustment to each vertex.

The global and the local interactions result from the effect of either a repulsive or an attractive force exerted by each vertex on every other vertex.

The adjustment of the location of at least some of the vertices may be further based on the effects of one or more additional forces acting on those vertices. The one or more additional forces may comprise one or more attractive forces acting between respective vertices of the graph. The one or more additional forces may comprise one or more repulsive forces acting between respective vertices of the graph.

The vertices may be grouped based on their location in the initial layout by: subdividing the initial layout into a plurality of subdivisions; and grouping any vertices that are located in the same subdivision. The plurality of subdivisions may be defined by a grid. Determining the effect of global interactions may comprise determining the aggregate effect of each group of vertices as a whole on each of the plurality of subdivisions.

Determining the effect of local interactions may comprise: subdividing the layout into a second plurality of subdivisions; grouping any vertices that are located in the same subdivision of the second plurality of subdivisions; and determining an aggregate effect of each group of vertices the subdivisions of the second plurality of subdivisions adjoining the subdivision in which the group is located. The second plurality of subdivisions may be defined by a second grid.

The global interactions may be determined at a lower resolution than the local interactions.

The method may be performed iteratively until an equilibrium is substantially reached.

According to a second aspect of this disclosure, there is provided a computer system a processor and a memory storing computer program code for performing a method according to the first aspect.

According to a third aspect of this disclosure, there is provided a computer program which, when executed by one or more processors, is arranged to carry out a method according to the first aspect.

### BRIEF DESCRIPTION OF THE FIGURES

In order that the present disclosure may be better understood, embodiments thereof will now be described, by way of example only, with reference to the accompanying drawings, in which:

FIG. 1 is a block diagram of a computer system suitable for the operation of embodiments of the present disclosure.

FIG. 2 is a flowchart illustrating a method for generating a force-directed layout for a graph according to this disclosure.

FIG. 3 shows an exemplary initial layout for an exemplary graph.

FIG. 4, which illustrates a grid overlaid over the area in which the initial layout of FIG. 3 was generated.

FIG. 5 provides a conceptual illustration of the aggregation of the effects of each group of vertices.

FIG. 6 illustrates another grid overlaid over the area in which the initial layout of FIG. 3 was generated.

### DETAILED DESCRIPTION

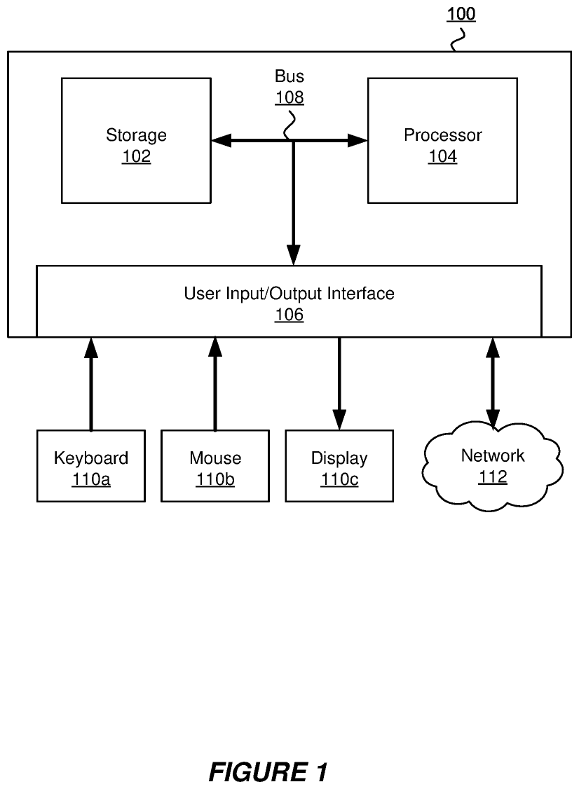

FIG. 1 is a block diagram of a computer system 100 suitable for the operation of embodiments of the present disclosure. The system 100 comprises includes: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response time, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs which, when executed by the processor 104, cause the processor 104 to carry out a method according to an embodiment of this disclosure, as discussed below (and accordingly configure the system 100 to be a system 100 according to an embodiment of this disclosure).

The input/output (I/O) interface 106 provides interfaces to devices 110 for the input or output of data, or for both the input and output of data. The devices 110 may include user input interfaces, such as a keyboard 110a or mouse 110b as well as user output interfaces, such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100, may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of this disclosure. As examples, the computer system 100 could include one or more of: a personal computer; a laptop; a tablet; a mobile telephone (or smartphone); a television set (or set top box); a games console; an augmented/virtual reality headset; a server; or indeed any other computing device with sufficient computing resources to carry out a method according to this disclosure.

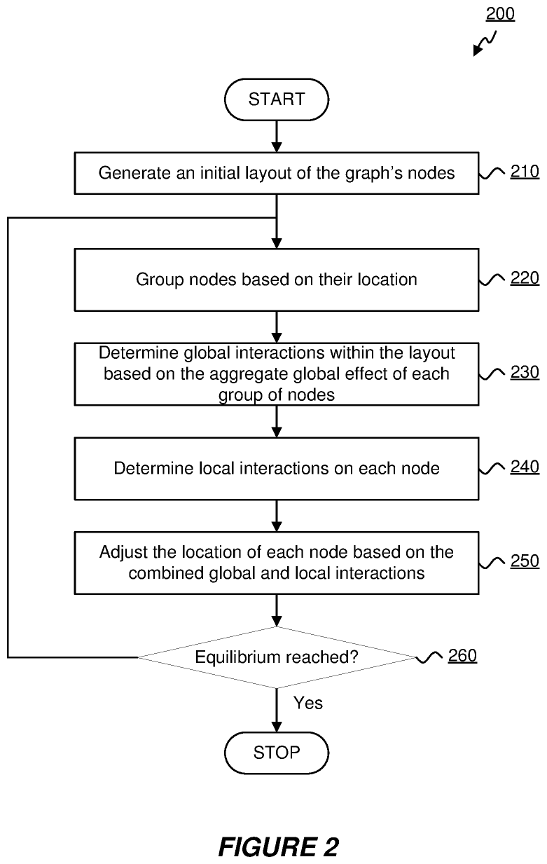

FIG. 2 is a flowchart illustrating a method 200 for generating a force-directed layout for a graph according to this disclosure. The method 200 may be performed by any suitable computer system 100 to create a visualization of the graph for a user. In some cases, the layout may be generated by one computer system 100, whilst a visualization based on the layout may be created and displayed to a user by another computer system 100. In other cases, the layout may be generated by the same computer system 100 which displays the visualization to the user.

The force-directed layout that is to be generated is based on a physical model in which forces are modelled as acting on each vertex. The layout is generated by determining locations for each vertex of the graph in which the forces acting on each vertex are substantially in equilibrium. A substantial equilibrium may be considered to be present when the forces acting on any vertex would not cause that vertex to move by an amount that is less a pre-determined threshold. The physical model includes at least one type of force that creates a field. That is to say, a force which acts throughout the entire space in which the layout is being created and results in interactions between each vertex and every other vertex regardless of whether those vertices are connected via an edge in the graph. This force can be attractive or repulsive in nature. For example, a physical model may be defined in which each vertex is considered to have an electrical charge and exert a repulsive force on every other vertex based, at least in part, on a distance between that vertex and another vertex in the layout according to Coulomb's law. Similarly, as a further example, a physical model may be defined in which each vertex is considered to generate a gravitational field that exerts an attractive force on every other vertex based, at least in part, on a distance between that vertex and another vertex in the layout according to Newton's law. The physical model may include forces between vertices that result from many different types of forces. Some of these forces may be modelled as acting on specific vertices rather than as a field that affects all vertices in the graph layout. For example, an attractive force may be modelled between any pairs of vertices that are connected by an edge that is based on a spring according to Hooke's law. Such forces would only (directly) affect the vertices associated with a particular edge. The layout may be determined within either a two-dimensional or three-dimensional space. As will be understood by the skilled person, where a three-dimensional layout is generated, a projection of the three-dimensional layout may be used to provide a visualization of the graph. Similarly, although the forces included in the physical model for generating a force-directed are typically analogues of forces that occur in nature, this need not necessarily be the case. That is to say, artificial forces that are not directly based on any natural phenomenon, or which utilize a different relationship from their natural analogue may be used instead or in addition (e.g. some force-directed systems use ‘springs’ whose attractive force is logarithmic rather than linear).

For simplicity, the remainder of the examples in this description will consider a physical model in which each vertex is considered to have a charge and exerts a force on every other vertex that is based on Coulomb's law, whilst each pair of vertices that are connected by an edge have an attractive force that is based on Hooke's law. Layouts resulting from such a physical model may be called Force-Spring layouts. However, it will be appreciated that the described method can be applied to generate force-directed layouts for graphs based on the application of physical models involving any other suitable combinations of different forces, as would be readily apparent to the skilled person.

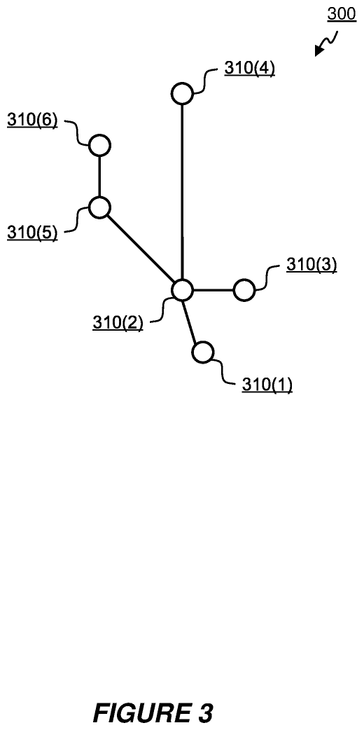

The method 200 begins at an operation 210. At operation 210, the method 200 generates an initial layout of the plurality of vertices. FIG. 3 shows an exemplary initial layout 300 for an exemplary graph. The graph comprises a plurality of vertices (or nodes) 310(1)-310(6), as well as a plurality of edges which each connect a respective pair of vertices, as will be readily recognized by those skilled in the art. Any suitable means that will be known to the skilled person may be used to generate the initial layout. For example, the vertices may be randomly placed in the two-dimensional or three-dimensional area within which the layout is to be created. As another example, the initial layout may be created by identifying the most connected vertex in the graph (or picking one at random, if there are multiple having the same level of connectivity) and placing that vertex in the middle. Having placed the center, any first-order vertices that are directly connected to that vertex can be placed on a circle of pre-determined radius surrounding the vertex at an even spacing. Then, any second-order vertices that are directly connected to a first-order vertex can be placed on a circle of twice the pre-determined radius surrounding the vertex at an even space. This can be repeated until all vertices have been placed. In any case, regardless of the technique used to generate the initial layout, the generation of the initial layout 300 should ideally be relatively fast by demanding relatively little processing resources. The initial layout 300 serves as the starting point which the method 200 improves upon by adjusting the locations of the vertices in the layout in a way which brings them closer to equilibrium, according to the forces and mechanics of the underlying physical model. Having generated an initial layout, the method 200 proceeds to an operation 220.

At operation 220, the method 200 groups the vertices of their graph based on their current location in the layout (e.g. in the initial layout 300).

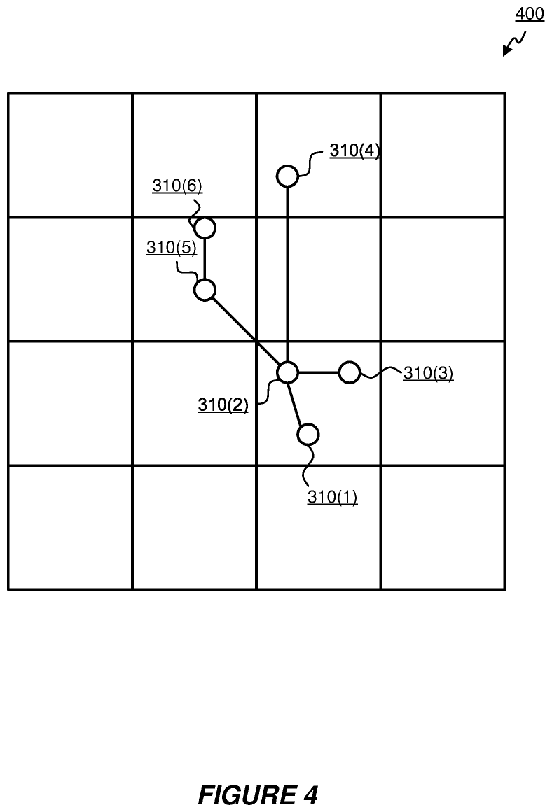

One way of grouping the vertices based on their location will now be discussed in conjunction with FIG. 4, which illustrates a grid 400 overlaid over (i.e. covering) the area in which the initial layout of FIG. 3 was being generated. This grid subdivides (or partitions) the layout area into a plurality of subdivisions (or portions), as defined by the squares of the grid. In this example, the grid defines 16 subdivisions, although of course any number of subdivisions may be defined depending on the size of the layout area and the desired resolution (i.e. size of portion), as will be discussed further below. All the vertices that are contained in a given subdivision may be grouped together into a single group. For example, in the example illustrated in FIG. 4, the vertices 310(1), 310(2) and 310(3) all lie in the same grid square and so are grouped together in a first group, the vertex 310(4) is the only vertex in its grid square and so is placed in a second group on its own, meanwhile the vertices 310(5) and 310(6) both lie in the same grid square and so are grouped together in a third group.

It will be appreciated that there are many ways of grouping the vertices based on their location. Where a grid is used, as in the above example, the subdivisions defined by such a grid need not necessarily be square. Any tessellating shapes may be used. Equally the size of the subdivisions defined by the grid need not necessarily be uniform. For example, the subdivisions in one part of the layout area may be larger than in another part of the layout area. Indeed, a grid need not necessarily be used to partition the layout area into portions. Other techniques, such as clustering, may be used to group the vertices based on their location instead.

To summarize, operation 220 allocates each vertex to a group, such that each group contains vertices that are relatively close to each other in the layout (i.e. located in the same general area). It will be appreciated that any number of vertices may be included in a group, including one (which in general will relate to relatively isolated vertices in the layout). The method 200 then proceeds to an operation 230.

At operation 230, the method 200 determines an aggregate effect of each individual group of vertices as a whole. The aggregate effect is the combined effect of the group of vertices. The aggregate effect can be determined by summing the force-generating property of each vertex in the group. The group of vertices can then conceptually be considered to be a single vertex located at the center of the group of vertices and have the combined force-generating abilities of the entire group. The center of the group of vertices may be generated purely geometrically or may be weighted based on the comparative force-generating capability of by each vertex (where each vertex may have a different force-generating capability, such as having different electrostatic charges). For example, where each vertex is considered to have a charge, the charge being the force-generating property since it determines the force a vertex exerts on every other vertex according to Coulomb's law, the charges for each vertex in the group are summed. The aggregate effect of the group of vertices may then be considered to be the same as a single vertex located at the center of the group of vertices and having the same total charge as all of the vertices in the group. Alternatively, instead of conceptually locating the vertex at the center of the vertices in the group, where the layout area is subdivided, such as by grid 400, the vertex may be conceptually located at the center of the subdivision that defines the group.

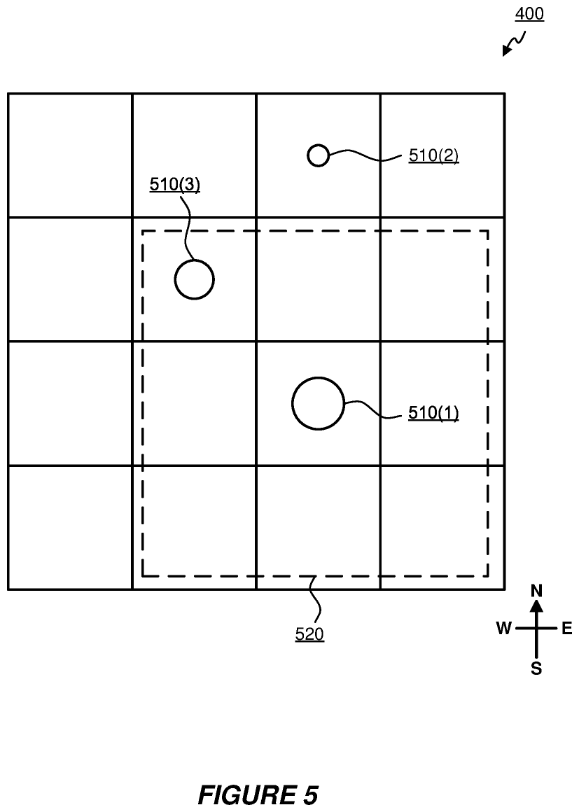

FIG. 5 provides a conceptual illustration of the aggregation of the effects of each group of vertices. In particular, the first group of vertices 310(1), 310(2) and 310(3) have conceptually been combined into a single vertex 510(1). This single vertex 510(1) is located in the center of the grid square that contains 310(1), 310(2) and 310(3) and has the combined charge of all three vertices (as represented in FIG. 5 by its size). The second group only included a single vertex 310(4) and has therefore conceptually been aggregated into a single vertex 510(2) having the same charge as that single vertex 310(4) and being located in the center of the grid square that contained that vertex. Finally, the third group of vertices 310(5) and 310(6) has conceptually been combined into a single vertex 510(3) having the combined charge of both vertices and being located in the center of the grid square that contained those vertices.

The aggregate effect of the groups of vertices can then be used to determine the effect of the global interactions between the vertices throughout the entire layout area. This can be determined for each vertex by assessing the total magnitude of the field caused by all the vertices in the graph at points either side of that vertex. The total magnitude of the field caused by all the vertices in the graph at those points can be determined by summing the fields caused by the aggregate effect of each group of vertices at those points. An overall force acting on the vertex as a result of the global interactions can then be derived by looking at the difference in the field on either side of the vertex along an axis for the vertex; this is repeated for a plurality of axes. The points around each vertex that are used for determining this overall force can be identified and evaluated individually for each vertex. That is to say, a point a predetermined distance either side of each vertex along predetermined axes may be identified and the total effect of all fields evaluated at those points to determine the effect of the global interactions on that vertex. A difference between the total fields either side of a vertex along an axis can be evaluated to determine a magnitude of the component of the force acting on that vertex along that axis. The total force can be determined by combining the components of the force acting along each axis that is evaluated, as will be readily understood by a person skilled in the art.

As an alternative to identifying and evaluating points individually for each vertex, where the layout area has been subdivided, such as through the overlaid grid illustrated in FIGS. 4 and 5, the points may be the center points of each (or at least some) of the surrounding subdivisions. This means that the effect on the first group of vertices 310(1), 310(2) and 310(3) can be determined based on the total magnitude of the field caused by each group of vertices at the center of each of the surrounding subdivisions (as indicated by the dashed line 520 in FIG. 5). The components of the total force resulting from global interactions on the first group of vertices may then be calculated along the North-South, East-West, North East-South West and North West-South East axes (although, of course, fewer axes may be used). Accordingly, the net force on each of the vertices 310(1), 310(2) and 310(3) in the first group resulting from the effect of the global interactions may be considered to be the same. Using this technique, the net force of the global interactions may effectively be determined for each group of vertices, rather than for each vertex individually.

In any case, having determined an effect of global interactions between the vertices of the graph in the layout, the method 200 proceeds to an operation 240.

At operation 240, the method 200 determines an effect of local interactions with the vertices located in a region of the layout proximate to the vertex. That is to say, a local (or localized) area surrounding each vertex is defined and the effects of the interactions with any vertices located in that local area on the vertex is evaluated. The effect of local interactions is determined in the same way as the global interactions discussed in operations 220 and 230, with the exception that interactions with any vertices located outside the local area are not evaluated when determining the effect of local interactions.

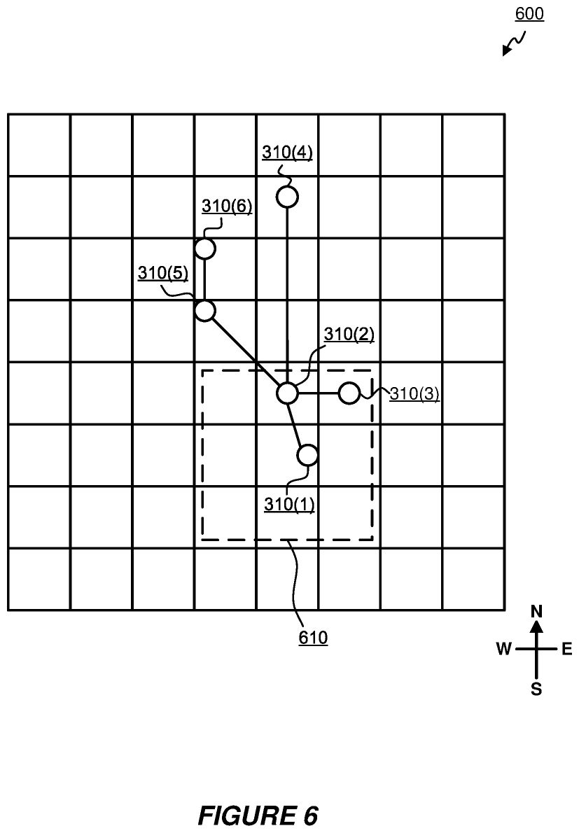

A different respective local area may be individually defined for each vertex, for example, by specifying that the local area of a vertex is an area of a predetermined size centered on that vertex. Alternatively, the local areas may also be defined by subdividing the grid into a plurality of subdivisions (or portions), again in a similar manner to that discussed above in relation to operations 220 and 230. As discussed in relation to operations 220 and 230, a grid may be defined to subdivide the layout area. FIG. 6 illustrates another grid 600 overlaid over the area in which the initial layout of FIG. 3 was generated. This grid 600 is a separate grid from the grid 400 which may be defined for performing operation 220 and 230 and provides a higher resolution (i.e. it subdivides the area into a greater number of smaller subdivisions). The local area for a vertex can then be determined as being a predetermined number of grid squares in each direction surrounding the grid square that a vertex is located in. This means that any vertices located in the same subdivision will have the same local area defined. For example, the dotted line illustrates a local area 610 for vertex 310(1) that is defined as being one grid square in each direction of the grid 600 (thereby to define a three-by-three grid). Therefore, in this example, the effect local interactions resulting from the forces exerted by vertices 310(2) and 310(3) will be evaluated as these vertices are located inside the local area 610 if vertex 310(1), whilst any effects of vertices 310(4) 310(5) and 310(6) will not be included as they are located outside the local area 610.

Similarly, the effect of the local interactions on a particular vertex, such as vertex 310(1), may be determined individually for each vertex within the local area 610. However, where the layout is subdivided, such as through the definition of grid 600, a similar technique of aggregating the effect of all the vertices located in each subdivision as used for operations 220 and 230 may be used, albeit at a higher resolution than was used during those operations. Indeed, it will be appreciated that since the local interactions are only determined within an area proximate to each vertex, the grid 600 used for determining the local interactions can be a much higher resolution than that used for determining the global interactions (where one is used), without a commensurate significant increase in processing requirements. Following this aggregation approach means that the effect of the local interactions on all vertices in a particular subdivision of the grid 600 may be considered to be the same.

Although operation 240 is shown following operations 220 and 230 in the flowchart illustrating the method 200 in FIG. 2, it will be appreciated that these two sets of operations are independent of each other and may be carried out in any order. Indeed, these sets of operations can also be carried out in parallel. In any case, having determined the effects of the local and global interactions on each vertex following completion of operations 220-240, the method 200 proceeds to an operation 250.

At operation 250, the method 200 adjusts the location of each vertex based, at least in part, on the combined effects of the global and local interactions acting on that vertex. That is to say, the forces resulting from the effects of all the vertices as well as those located in the local area of the vertex as determined in operation 230 and 240 respectively are combined and used to determine a new position for the vertex in the layout area according the mechanics of the underlying physical model. The underlying physical model may include other additional forces that act on at least some of the vertices, in which case, the adjustment of the location of those vertices may also take such additional forces into account. For example, in the graph 300 illustrated in FIG. 3, spring forces may be considered to act between pairs of vertices that are connected via an edge. As will be appreciated such forces may be attractive in nature and therefore serve to counterbalance (at least partially) some of the repulsive forces that each vertex experiences. Of course, any other type of forces, including momentum, friction, gravity, magnetic fields any others may be included in the physical model as forces that are additionally taken into account when determining the new locations for vertices in the layout. Having adjusted the location of the vertices in the layout based on the combined global and local interactions occurring within the graph layout, the method 200 proceeds to an operation 260.

At operation 260, the method 200 optionally determines whether an equilibrium has been reached between all the forces acting on each vertex according to the underlying physical model. If so, the method 200 ends. Otherwise, the method 200 may repeat (or reiterate) operations 220, 230, 240 and 250 to further refine the layout of the graph until equilibrium has been substantially reached. A substantial equilibrium may be considered to be present when the forces acting on any vertex would not cause that vertex to move by an amount that is less a pre-determined threshold. Of course, it will be appreciated that with each iteration of the method 200, the layout may be improved. Accordingly, the force-directed layout that is provided by a single pass of method 200 may be considered sufficient. Alternatively, the method 200 may re-iterate as many times as possible within a certain amount of processing time that has been allocated to the generation of the force-directed layout.

By separating out the consideration of the long-range global interactions between vertices in the graph from the consideration of the short-range local interactions between vertices, techniques of this disclosure enable a force-directed graph layout to be generated more efficiently. In particular, the long-range interactions can be determined globally at a low resolution, with the effects of proximate vertices being amalgamated, whilst the short-range interactions can be determined locally at a higher resolution. As a result, the generation of a force-directed layout can be achieved with a computational complexity that has a linear relationship with the number of vertices in the graph (rather than exponential). This makes it possible to generate layouts for visualizing graphs containing a much higher numbers of vertices in real-time (or near real-time).

Insofar as embodiments of this disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure. It will be understood by those skilled in the art that, although the present disclosure has been described in relation to the above described example embodiments, techniques of this disclosure are not limited thereto and there are many possible variations and modifications which fall within the scope of the disclosure. The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for generating a force-directed layout for a graph comprising a plurality of vertices, wherein the layout is dependent on a force exerted by each vertex on every other vertex, the method comprising:
generating an initial layout of the plurality of vertices;
determining an effect of global interactions based on a force between vertices by:
grouping vertices based on a respective location of each vertex in the initial layout, and
determining an aggregate effect of each group of vertices as a whole;
determining, for each vertex, an effect of local interactions based on the force with the vertices located in a region of the initial layout proximate to the vertex;
determining, for each vertex, an adjustment to the location of the vertex based, at least in part, on combined effects of the global interactions and the local interactions on the vertex; and
applying the respective determined adjustment to each vertex.

2. The method of claim 1, wherein the force comprises a repulsive force, and wherein the global interactions and the local interactions result from an effect of the repulsive force exerted by each vertex on every other vertex.

3. The method of claim 1, wherein the force comprises an attractive force, and wherein the global interactions and the local interactions result from effect of the attractive force exerted by each vertex on every other vertex.

4. The method of claim 1, wherein the adjustment of the location of at least some of the vertices is further based on effects of one or more additional forces acting on those vertices.

5. The method of claim 4, wherein the one or more additional forces comprise one or more attractive forces acting between respective vertices of the graph.

6. The method of claim 4, wherein the one or more additional forces comprise one or more repulsive forces acting between respective vertices of the graph.

7. The method of claim 1, wherein grouping the vertices based on their location in the initial layout comprises:
subdividing the initial layout into a first plurality of subdivisions; and
grouping vertices that are located in a common subdivision of the first plurality of subdivisions.

8. The method of claim 7, wherein determining the effect of global interactions comprises determining an aggregate effect of each group of vertices as a whole on each of the first plurality of subdivisions.

9. The method of claim 7, wherein the first plurality of subdivisions is defined by a grid.

10. The method of claim 7, wherein determining the effect of local interactions comprises:
subdividing the layout into a second plurality of subdivisions;
grouping vertices that are located in the a common subdivision of the second plurality of subdivisions; and
determining an aggregate effect of each group of vertices of each of the second plurality of subdivisions adjoining the subdivision in which the group is located.

11. The method of claim 10, wherein the second plurality of subdivisions is defined by a grid.

12. The method of claim 10, wherein the global interactions are determined at a lower resolution than the local interactions.

13. The method of claim 1, wherein the method is performed iteratively until an equilibrium is reached.

14. A computer system comprising a processor and a memory storing computer program code for causing the processor to generate a force-directed layout for a graph comprising a plurality of vertices, wherein the layout is dependent on a force exerted by each vertex on every other vertex, by:
generating an initial layout of the plurality of vertices;
determining an effect of global interactions based on the force between vertices by:
grouping vertices based on a respective location of each vertex in the initial layout; and
determining an aggregate effect of each group of vertices as a whole;
determining, for each vertex, an effect of local interactions based on the force with the vertices located in a region of the initial layout proximate to the vertex;
determining, for each vertex, an adjustment to the location of the vertex based, at least in part, on combined effects of the global interactions and the local interactions on the vertex; and
applying the respective determined adjustment to each vertex.

15. A non-transitory computer-readable storage medium storing a computer program which, when executed by one or more processors, causes the one or more processors to carry out a method according to claim 1.
